(19) United States
(12) Patent Application Publication
(10) Pub. No.: US 2024/0134615 A1
(43) Pub. Date: Apr. 25, 2024

(54) METHOD AND APPARATUS FOR INFORMATION PROCESSING

(71) Applicant: Fujitsu Limited, Kawasaki-shi (JP)

(72) Inventor: Yuji MIZOBUCHI, Kawasaki (JP)

(73) Assignee: Fujitsu Limited, Kawasaki-shi (JP)

(21) Appl. No.: 18/471,097

(22) Filed: Sep. 19, 2023

(30) Foreign Application Priority Data
Oct. 24, 2022 (JP) 2022-170390

(51) Int. Cl. G06F 8/36; G06F 11/34

(52) U.S. Cl. CPC G06F 8/36; G06F 11/3466

(57) ABSTRACT

A computer acquires cluster data and performance data. The cluster data represents classification results obtained by classifying multiple sample programs into two or more clusters and arranging the clusters in multiple levels in such a manner that each level contains a different number of clusters. The performance data represents an execution performance of each sample program. The computer calculates, for each of two or more clusters in each level, a first evaluation value based on an index value for reusability of two or more sample programs belonging to the cluster and the execution performances of those sample programs. The computer also calculates, for each level, a second evaluation value based on the first evaluation values corresponding to the two or more clusters of the level. The computer selects, based on the second evaluation values corresponding to the multiple levels, the classification results of a level amongst the multiple levels.

### CROSS-REFERENCE TO RELATED APPLICATION

This application is based upon and claims the benefit of priority of the prior Japanese Patent Application No. 2022-170390, filed on Oct. 25, 2022, the entire contents of which are incorporated herein by reference.

### FIELD

The embodiments discussed herein relate to an information processing method and information processing apparatus.

### BACKGROUND

Information processing apparatuses may store reusable programs as software components. Using the stored software components, software developers are able to perform programming efficiently. Software components may be created by collecting various existing programs as sample programs and analyzing the collected sample programs. The information processing apparatuses may assist in creating software components from such sample programs.

For example, there is a proposed component identification method of parsing source code containing multiple classes and identifying, as a component, a cluster of classes which is relatively independent of other classes. The proposed component identification method gives each class features that indicate presence or absence of calls to other classes, and defines inter-class similarities based on the features. The component identification method performs hierarchical clustering in which multiple clusters each containing one or more classes are combined in stages based on the similarities. Herewith, a tree diagram called dendrogram representing a tree-like hierarchical structure for the multiple classes is generated. See, for example, the following non-patent literature.

Jian Feng Cui and Heung Seok Chae, “Applying agglomerative hierarchical clustering algorithms to component identification for legacy systems”, Information and Software Technology, Volume 53, Issue 6, pages 601-614, June 2011.

### SUMMARY

According to one embodiment, there is provided a non-transitory computer-readable recording medium storing therein a computer program that causes a computer to execute a process including acquiring cluster data and performance data, the cluster data representing classification results obtained by classifying a plurality of sample programs into two or more clusters and arranging the two or more clusters in a plurality of levels in such a manner that each of the plurality of levels contains a different number of the two or more clusters, the performance data representing an execution performance of each of the plurality of sample programs; calculating, for each of the two or more clusters in each of the plurality of levels, a first evaluation value based on an index value for reusability of two or more sample programs belonging to the cluster and the execution performances of the two or more sample programs; calculating, for the level, a second evaluation value based on two or more first evaluation values corresponding to the two or more clusters; and selecting, based on the second evaluation values corresponding to the plurality of levels, the classification results of one level amongst the plurality of levels.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processor according to a first embodiment;

FIG. 2 illustrates a hardware example of an information processor of a second embodiment;

FIG. 3 illustrates an example of machine learning scripts and model accuracies;

FIG. 4 illustrates a division example of a machine learning script;

FIG. 5 illustrates an example of features of sample programs;

FIG. 6 illustrates an example of hierarchical clustering and cluster evaluation values;

FIG. 7 illustrates an example of trade-off between cluster size and cohesion degree;

FIG. 8 illustrates an example of trade-off between mean and variance of model accuracy;

FIG. 9 is a block diagram illustrating an example of functions of the information processor; and

FIG. 10 is a flowchart illustrating an example of a clustering procedure.

### DESCRIPTION OF EMBODIMENTS

Information processors may produce, from a set of sample programs, classification results with multiple levels having different numbers of clusters, like the clustering method described in the aforementioned literature (“Applying agglomerative hierarchical clustering algorithms to component identification for legacy systems”). One software component may be created from one cluster in a level.

However, a large number of sample programs collected may produce classification results with many levels having different numbers of clusters. For example, in hierarchical clustering, a dendrogram with deep hierarchical levels is generated. In this case, it is a heavy burden to manually determine which level of clusters is suitable for software componentization.

Several embodiments will be described below with reference to the accompanying drawings.

### (a) First Embodiment

A first embodiment is described hereinafter.

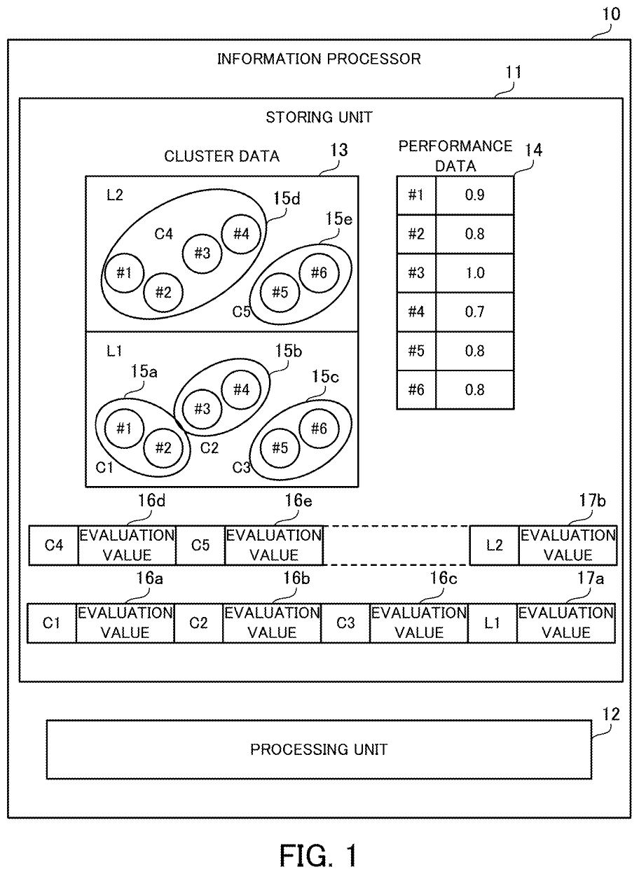

FIG. 1 illustrates an information processor according to the first embodiment.

An information processor 10 of the first embodiment supports creation of reusable software components from a set of sample programs. Software components may also be called code instances, code patterns, program components, code snippets, programming idioms, and the like. The information processor 10 may be a client device or server device. The information processor 10 may be called a computer, analysis device, or clustering device.

The information processor 10 includes a storing unit 11 and a processing unit 12. The storing unit 11 may be volatile semiconductor memory, such as random access memory (RAM), or a non-volatile storage device, such as a hard disk drive (HDD) or flash memory. The processing unit 12 is, for example, a processor, such as a central processing unit (CPU), graphics processing unit (GPU), or digital signal processor (DSP). Note however that the processing unit 12 may include an electronic circuit, such as an application specific integrated circuit (ASIC) or field programmable gate array (FPGA). The processor executes programs stored in memory, such as RAM, (or in the storing unit 11). The term “multiprocessor”, or simply “processor”, may be used to refer to a set of multiple processors.

The storing unit 11 stores cluster data 13 and performance data 14. The cluster data 13 is classification results obtained by classifying multiple sample programs into two or more clusters. The classification results have multiple levels with different numbers of clusters. Each sample program is part or the whole of an existing program. Such sample programs may be any of the following: source code; program units having certain functionalities, such as functions and classes; n continuous lines of source code (n=1, 2, 3, . . . ); and machine learning scripts for training a machine learning model.

Clustering of multiple sample programs may be performed by the information processor 10 or a different information processor. The multiple sample programs are classified into two or more clusters in such a manner that sample programs with close features belong to the same cluster and those with features far apart from each other belong to different clusters. The features may be calculated from character strings included in the sample programs, or may be calculated from execution states of the sample programs, such as memory states during execution.

The cluster data 13 is generated using a clustering algorithm, such as hierarchical clustering or k-means. In the case of hierarchical clustering, first, multiple sample programs are classified into different clusters. Inter-cluster distances (i.e., distances between clusters) are calculated in a given hierarchical level, and a pair of clusters with the shortest distance is integrated into one cluster in the hierarchical level one level above the given hierarchical level. Integration of clusters is repeated until the number of clusters eventually becomes 1. Multiple hierarchical levels generated by hierarchical clustering correspond to the multiple levels described above.

For example, the cluster data 13 includes classification results of levels L1 and L2 for sample programs *1 to *6. The classification results of the level L1 indicate a cluster 15a (C1) including the sample programs *1 and *2; a cluster 15b (C2) including the sample programs *3 and *4; and a cluster 15c (C3) including the sample programs *5 and *6. The classification results of the level L2 indicate a cluster 15d (C4) including the sample programs *1 to *4; and a cluster 15e (C5) including the sample programs *5 and *6. Thus, the level L2 has a smaller number of clusters than the level L1.

The performance data 14 indicates an execution performance of each of the multiple sample programs. The execution performance may be measured by executing each sample program. In this case, the execution performance may be measured by the information processor 10 or a different information processor. If each sample program is a machine learning script, the execution performance is, for example, the prediction accuracy of a machine learning model trained by the machine learning script. In that case, the execution performance is represented by a numerical value, for example, between 0 and 1, inclusive.

The processing unit 12 selects, based on the cluster data 13 and the performance data 14, the classification results of one of the multiple levels represented by the cluster data 13. One software component is created from one cluster included in the selected level. The processing unit 12 evaluates multiple levels as follows in order to select an appropriate level.

The processing unit 12 calculates a first evaluation value for each of two or more clusters in each of the multiple levels. The first evaluation value may be called cluster evaluation value. For example, a cluster with a higher first evaluation value is more suitable to be made into a component.

In order to calculate the first evaluation value, the processing unit 12 uses a cohesion degree according to the variance of features of two or more sample programs included in each cluster. The cohesion degree increases as the variance of the features within the cluster decreases. The cohesion degree may increase as the distances to other clusters increase. The Calinski-Harabasz index or the Davies-Bouldin index may be used as an index of the cohesion degree. For example, the higher the cohesion degree, the higher the first evaluation value.

In addition, in calculating the first evaluation value, the processing unit 12 further uses the execution performances of the two or more sample programs included in the cluster. For example, the processing unit 12 uses the mean and variance of the execution performances associated with the cluster to calculate the first evaluation value. For example, the higher the mean of the execution performances, the higher the first evaluation value, and the smaller the variance of the execution performances, the higher the first evaluation value.

In addition, to calculate the first evaluation value, the processing unit 12 may further use the cluster size which is the number of sample programs included in the cluster. The first evaluation value may be calculated from a first index value indicating the cluster size, a second index value indicating the cohesion degree, a third index value indicating the mean of the execution performances, and a fourth index value indicating the variance of the execution performances. The first evaluation value may be the product of the first index value, the second index value, the third index value, and the reciprocal of the fourth index value.

The processing unit 12 calculates a second evaluation value for each of the multiple levels based on two or more first evaluation values corresponding to the two or more clusters included in the level. The second evaluation value may be called level evaluation value or hierarchical level evaluation value. The processing unit 12 calculates, for example, the sum of the two or more first evaluation values as the second evaluation value. For example, the processing unit 12 calculates evaluation values 16a, 16b, and 16c corresponding to the clusters 15a, 15b, and 15c, respectively, and then combines the evaluation values 16a, 16b, and 16c to obtain an evaluation value 17a for the level L1. In addition, the processing unit 12 calculates evaluation values 16d and 16e corresponding to the clusters 15d and 15e, respectively, and then combines the evaluation values 16d and 16e to obtain an evaluation value 17b for the level L2.

The processing unit 12 selects a suitable level for componentization based on multiple second evaluation values individually corresponding to each of the multiple levels. For example, the processing unit 12 compares the second evaluation values among the multiple levels and selects a level with the highest second evaluation value. For example, when the evaluation value 17b is higher than the evaluation value 17a, the classification results of the level L2 may be selected. In this case, one software component may be created from each of the clusters 15d and 15e.

The processing unit 12 outputs the classification results of the selected level. The processing unit 12 may store the classification results of the selected level in a non-volatile storage device; display them on a display device; and/or transmit them to different information processors. The processing unit 12 may also prompt the user to create software components from clusters included in the selected level. The user may determine a common program pattern from two or more sample programs included in each cluster, and may create a software component that represents the determined program pattern.

In addition, the processing unit 12 may present one sample program or a small number of sample programs included in each cluster to the user as software component candidates. The sample programs to be presented may be central sample programs which have features close to the mean features of the cluster. In addition, the processing unit 12 may rank the two or more sample programs included in the cluster according to some criteria and present the ranking information to the user.

As has been described above, the information processor 10 of the first embodiment obtains the cluster data 13 representing classification results of sample programs arranged in multiple levels with different numbers of clusters and the performance data 14 representing execution performances of the sample programs. The information processor 10 calculates the first evaluation value for each cluster based on the cohesion degree according to the variance of the features of the sample programs included in the cluster and the execution performances of the sample programs. The information processor 10 calculates the second evaluation value for each level based on the first evaluation values of the clusters included in the level. Then, based on the calculated second evaluation values, the information processor 10 selects the classification results of one level.

Herewith, the classification results including clusters suitable for creating software components are identified amongst various classification results of multiple levels with different numbers of clusters. For example, a hierarchical level including suitable clusters is identified amongst the results of hierarchical clustering. Therefore, even when a large number of sample programs is collected, it is possible to streamline the creation of software components.

Among the information used to calculate the first evaluation value, the cohesion degree relates to reusability indicating that similar program patterns appear with high frequency. In addition, the execution performance relates to the utility of the software component in contributing to software quality improvement. Hence, software components created from clusters with high first evaluation values are expected to have high reusability and utility and, therefore, the quality of the software components is improved.

Note that the multiple levels may be multiple hierarchical levels generated by hierarchical clustering. This allows selection of an appropriate hierarchical level from a dendrogram with deep hierarchical levels, and the load of componentization work is alleviated compared to the case of manually searching for an appropriate hierarchical level.

The execution performance of each sample program may be the prediction accuracy of a machine learning model trained using the sample program. This is expected to create useful software components for programming of machine learning scripts. Note here that existing machine learning scripts are often not structured based on functions, unlike business system programs written in object-oriented languages. In addition, existing machine learning scripts are often difficult to be distinguished by domains indicating their application areas. As such, miscellaneous machine learning scripts may be collected, and classification results of a large number of levels having different numbers of clusters may be generated from the many machine learning scripts. Even in this situation, the information processor 10 is able to select classification results of an appropriate level.

The first evaluation value for each cluster may be calculated based on the first index value indicating the cluster size, the second index value indicating the cohesion degree, the third index value indicating the mean of the execution performances, and the fourth index value indicating the variance of the execution performances. The cluster size relates to reusability of a software component to be created. Using the cluster size and the cohesion degree allows adequately divided clusters to have high first evaluation values. In addition, using the mean and the variance of the execution performances allows clusters with high average and little variation in the execution performances to have high first evaluation values. As a result, the suitability of clusters is determined appropriately from a software componentization point of view.

### (b) Second Embodiment

A second embodiment is described next.

An information processor 100 of the second embodiment collects and analyzes existing machine learning scripts, and supports creation of reusable and useful software components. The information processor 100 may be a client device or a server device. The information processor 100 may be called a computer, analysis device, or clustering device. The information processor 100 corresponds to the information processor 10 of the first embodiment.

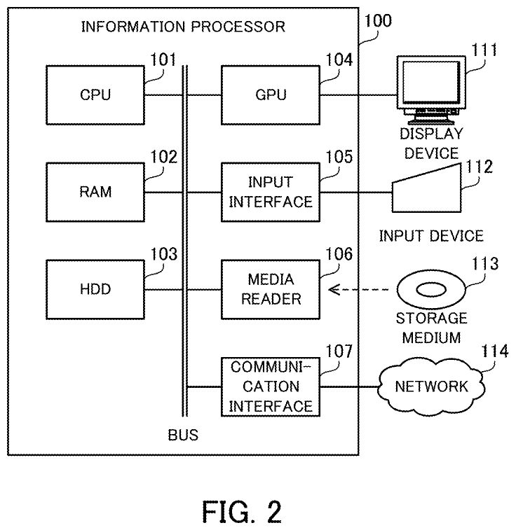

FIG. 2 illustrates a hardware example of the information processor of the second embodiment.

The information processor 100 includes a CPU 101, a RAM 102, an HDD 103, a GPU 104, an input interface 105, a media reader 106, and a communication interface 107, which are all connected to a bus. The CPU 101 corresponds to the processing unit 12 of the first embodiment. The RAM 102 or the HDD 103 corresponds to the storing unit 11 of the first embodiment.

The CPU 101 is a processor configured to execute program instructions. The CPU 101 reads out programs and data stored in the HDD 103, loads them into the RAM 102, and executes the loaded programs. Note that the information processor 100 may include two or more processors.

The RAM 102 is volatile semiconductor memory for temporarily storing therein programs to be executed by the CPU 101 and data to be used by the CPU 101 for its computation. The information processor 100 may be provided with a different type of volatile memory other than RAM.

The HDD 103 is a non-volatile storage device to store therein software programs, such as an operating system (OS), middleware, and application software, as well as various types of data. The information processor 100 may be provided with a different type of non-volatile storage device, such as flash memory or a solid state drive (SSD).

The GPU 104 performs image processing in cooperation with the CPU 101, and displays video images on a screen of a display device 111 coupled to the information processor 100. The display device 111 may be a cathode ray tube (CRT) display, a liquid crystal display (LCD), an organic electro-luminescence (OEL) display, or a projector. An output device, such as a printer, other than the display device 111 may be connected to the information processor 100. In addition, the GPU 104 may be used as a general-purpose computing on graphics processing unit (GPGPU). The GPU 104 may execute a program according to an instruction from the CPU 101. The information processor 100 may have volatile semiconductor memory other than the RAM 102 as GPU memory.

The input interface 105 receives an input signal from an input device 112 connected to the information processor 100. Various types of input devices may be used as the input device 112, for example, a mouse, a touch panel, or a keyboard. Multiple types of input devices may be connected to the information processor 100.

The media reader 106 is a device for reading programs and data recorded on a storage medium 113. The storage medium 113 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 106 copies the programs and data read out from the storage medium 113 to a different storage medium, for example, the RAM 102 or the HDD 103. The read programs may be executed by the CPU 101.

The storage medium 113 may be a portable storage medium and used to distribute the programs and data. In addition, the storage medium 113 and the HDD 103 may be referred to as computer-readable storage media.

The communication interface 107 communicates with different information processors via a network 114. The communication interface 107 may be a wired communication interface connected to a wired communication device, such as a switch or router, or may be a wireless communication interface connected to a wireless communication device, such as a base station or access point.

Next described are clusters of sample programs to be analyzed.

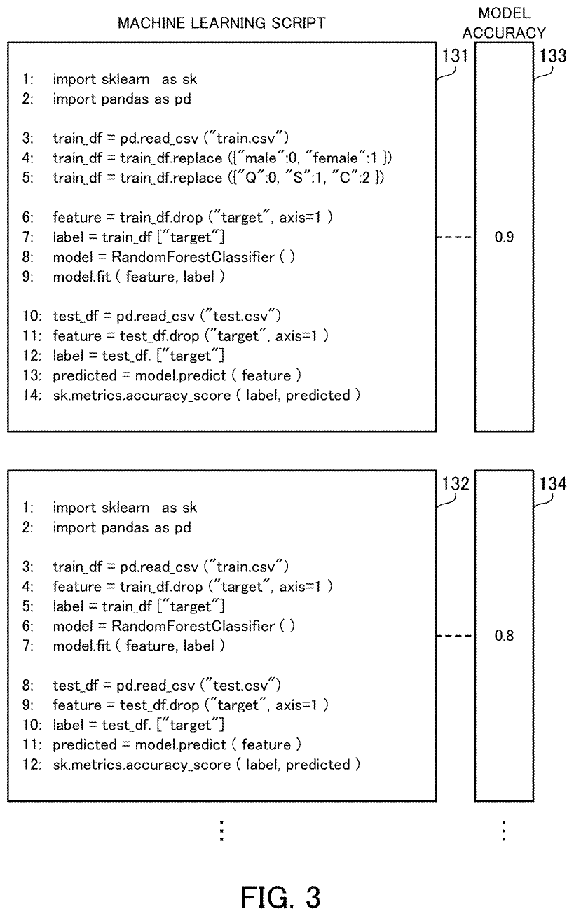

FIG. 3 illustrates an example of machine learning scripts and model accuracies.

The information processor 100 stores multiple machine learning scripts, including machine learning scripts 131 and 132. The machine learning scripts are source code that defines procedures of machine learning. The machine learning involves training a machine learning model using training data and measuring the model accuracy of the machine learning model using test data.

The machine learning scripts may use machine learning libraries including classes and methods. The machine learning model is, for example, a random forest, support vector machine, neural network, or the like. Accuracy (correct answer rate), for example, is used as a metric of the model accuracy. The accuracy takes a numerical value between 0 and 1, inclusive, and the higher the accuracy, the better the machine learning model.

The training data and the test data are, for example, tabular data, such as comma-separated values (CSV). The tabular data includes multiple columns and multiple records. Some of the columns are used for explanatory variables while a different column is used for an objective variable. The values of the explanatory variables are input data that enters the machine learning model. The values of the objective variable are teacher labels that indicate correct answers to outputs of the machine learning model. The machine learning scripts may perform preprocessing on the tabular data. The preprocessing includes, for example, normalization for converting the values of specific columns in the tabular data into numerical values within a certain range.

The machine learning script 131 contains 14 lines of code without blank lines. The code may also be called instructions or statements. The machine learning script 131 preprocesses a training data table, then designates, in the training data table, columns representing explanatory variables and a column representing an objective variable, and trains a random forest as a machine learning model. The machine learning script 131 designates, in a test data table, columns representing the explanatory variables and a column representing the objective variable, calculates a predicted value by inputting the values of the explanatory variables to the random forest, and compares the predicted value with a teacher label to calculate the accuracy as the model accuracy.

The machine learning script 132 includes 12 lines of code without blank lines. The machine learning script 132 does not include preprocessing code corresponding to the fourth and fifth lines of the machine learning script 131. The machine learning script 132 is otherwise the same as the machine learning script 131.

The information processor 100 stores therein training data and test data used in each machine learning script, in association with the machine learning script. The information processor 100 executes the machine learning script using the stored training data and test data to measure the model accuracy of a machine learning model trained in the machine learning script. The information processor 100 stores the obtained model accuracy in association with the machine learning script. Note however that the model accuracy may be measured by a different information processor.

For example, the information processor 100 executes the machine learning script 131 to measure a model accuracy 133. The information processor 100 also executes the machine learning script 132 to measure a model accuracy 134. Note that the information processor 100 may define features of each sample program based on memory states at the time of execution, as will be described later. In this case, the information processor 100 stores, as an execution history, a memory image for each step (e.g., for each line) when executing a machine learning script.

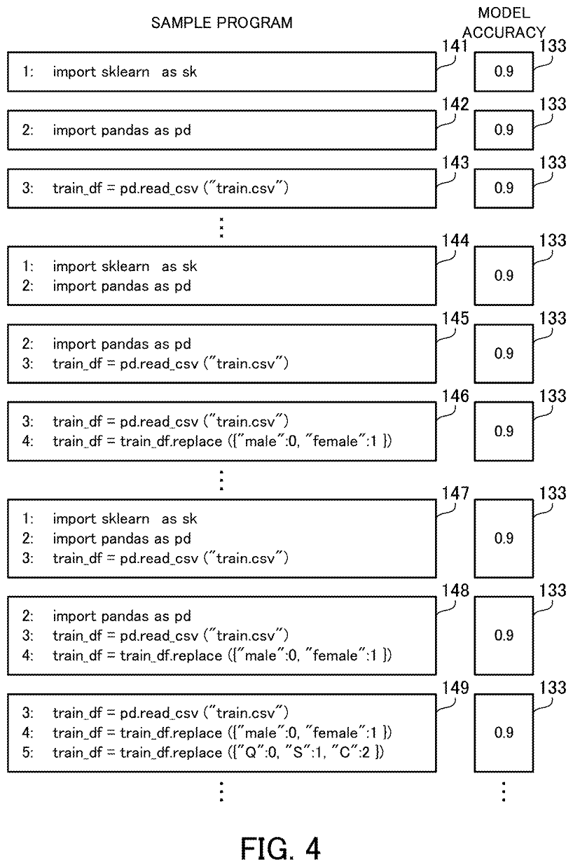

FIG. 4 illustrates a division example of a machine learning script.

The information processor 100 divides each of multiple machine learning scripts to extract multiple sample programs which are candidates for reusable software components. The machine learning scripts are often poorly structured, unlike large business system programs. Therefore, it is difficult for the information processor 100 to identify, from the machine learning scripts, program units, such as classes and functions, that represent functional blocks. In view of this, the information processor 100 exhaustively extracts n consecutive lines (n=1, 2, 3, and so forth) of code included in each machine learning script as sample programs.

For example, the information processor 100 extracts, from the machine learning script 131, a sample program 141 representing the code on the first line, a sample program 142 representing the code on the second line, and a sample program 143 representing the code on the third line 143. Thus, the information processor 100 extracts 14 sample programs, each representing one line of code.

The information processor 100 also extracts a sample program 144 representing the code on the first and second lines, a sample program 145 representing the code on the second and third lines, and a sample program 146 representing the code on the third and fourth lines. Thus, the information processor 100 extracts 13 sample programs each representing two consecutive lines of code. Further, the information processor 100 extracts a sample program 147 representing the code on the first to third lines, a sample program 148 representing the code on the second to fourth lines, and a sample program 149 representing the code on the third to fifth lines. Thus, the information processor 100 extracts 12 sample programs each representing three consecutive lines of code.

The number of lines that are included in one sample program may have a predetermined upper limit or no upper limit. The information processor 100 extracts multiple sample programs also from the machine learning script 132, as with the machine learning script 131. The information processor 100 assigns the model accuracy measured for the original machine learning script to each extracted sample program. For example, the information processor 100 assigns the model accuracy 133 of the machine learning script 131 to each of the sample programs 141 to 149.

Note that when a reference machine learning script exists, the information processor 100 may extract a difference between the reference machine learning script and another machine learning script as a sample. For example, if the machine learning script 132 is used as a reference, the information processor 100 extracts the code on the fourth and fifth lines from the machine learning script 131 as a sample program. Extraction of the difference facilitates identification of codes that contribute to improved model accuracy.

In this case, the information processor 100 may assign, to the sample program made of the extracted difference, a relative model accuracy indicating the difference from the model accuracy of the reference machine learning script. The relative model accuracy may be a negative number. For example, the information processor 100 assigns a relative model accuracy of +0.1 to the fourth and fifth lines of the machine learning script 131.

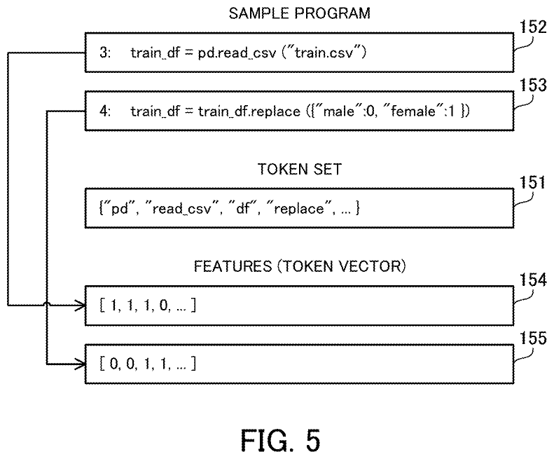

FIG. 5 illustrates an example of features of sample programs.

The information processor 100 calculates features of each sample program in order to define the “distance” which indicates the degree of similarity between sample programs. The features are expressed as a vector enumerating two or more numerical values corresponding to two or more dimensions. The following description of the second embodiment assumes the case where the features are calculated from a character string itself included in each sample program. Note however that the information processor 100 may calculate the features by other methods, as will be described below.

The information processor 100 extracts one or more tokens from each of multiple sample programs. Each token is a character string that has meaning in a programming language, such as a variable name or function name, and may be called a word. The information processor 100 detects delimiters, such as spaces, dots, and commas, and divides each sample program into tokens.

Note however that, user-defined variable names are less important in determining the degree of similarity between sample programs. This is because two sample programs may perform substantially the same data processing even if the user-defined variable names are different. Therefore, the information processor 100 may extract, as tokens, only known names, such as library names, class names of classes included in the libraries, and method names of methods included in the libraries.

The information processor 100 generates a token set 151 which enumerates tokens appearing one or more times in multiple sample programs. The information processor 100 refers to the token set 151 to calculate one set of features for each sample program. The set of features may be referred to as a token vector and has the same number of dimensions as the token set 151. A dimension value corresponding to a token appearing one or more times in the sample program is “1”, and a dimension value corresponding to a token not appearing even once in the sample program is “0”.

For example, the first dimension of the token set 151 indicates a token “pd”; the second dimension indicates a token “read_csv”; the third dimension indicates a token “df”; and the fourth dimension indicates a token “replace”. The information processor 100 calculates a set of features 154 from a sample program 152 and a set of features 155 from a sample program 153.

The sample program 152 includes the tokens “pd”, “read_csv”, and “df” but does not include the token “replace”. Therefore, the values of the first to third dimensions of the features 154 are “1” while the value of the fourth dimension of the features 154 is “0”. The sample program 153 does not include the tokens “pd” and “read_csv” but includes the tokens “df” and “replace”. Therefore, the values of the first and second dimensions of the features 155 are “0” while the values of the third and fourth dimensions of the features 155 are “1”.

Note that the information processor 100 may calculate features from execution histories of a machine learning script. For example, the information processor 100 extracts, from a memory image saved at the start or end point of each sample program, tabular data at that point. The information processor 100 may calculate, as the features, statistics, such as the average value, maximum value, and minimum value of each column included in the tabular data. When tabular data with different structures are used depending on sample programs, or when preprocessing is performed on the tabular data, statistics of the tabular data may be useful features representing characteristics of the sample program.

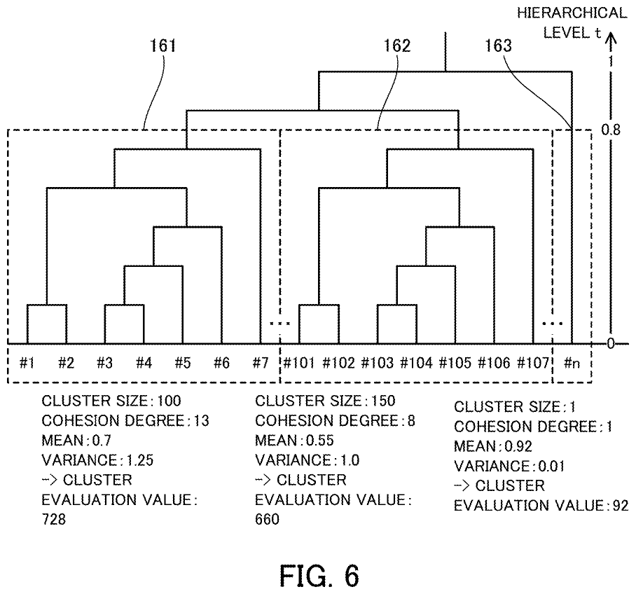

FIG. 6 illustrates an example of hierarchical clustering and cluster evaluation values.

The information processor 100 performs hierarchical clustering on the multiple sample programs extracted above using the features calculated in the aforementioned manner. In the hierarchical clustering, the information processor 100 first generates the same number of clusters as the sample programs, and classifies each of the multiple sample programs into a different cluster. The information processor 100 calculates the distance between clusters (inter-cluster distance) based on the features of sample programs individually belonging to the clusters, and integrates a pair of clusters with the shortest inter-cluster distance into a single cluster. The information processor 100 repeats the calculation of the inter-cluster distance and the integration of paired clusters until the number of clusters becomes one.

The distance between two sample programs is, for example, the Euclidean distance between two sets of features. The inter-cluster distance is, for example, the minimum or maximum distance amongst distances between sample programs belonging to different clusters. The method using the minimum distance is sometimes called the shortest distance method, and the method using the maximum distance is sometimes called the longest distance method. Alternatively, the average distance between sample programs belonging to different clusters may be used instead.

Herewith, a dendrogram as illustrated in FIG. 6 is generated. The dendrogram includes a root node representing one cluster containing all sample programs and leaf nodes representing multiple sample programs each belonging to a different cluster. In the dendrogram, a hierarchical level t is defined, which indicates the stage of hierarchical clustering progression. The hierarchical level of the leaf nodes has t=0, and the hierarchical level of the root node has t=1. The hierarchical level t takes a numerical value between 0 and 1, inclusive.

When one hierarchical level is selected from the dendrogram, one or more clusters residing in the selected hierarchical level are identified. A hierarchical level other than t=0 and t=1 is usually selected. The user creates one software component from each of the identified clusters. Two or more sample programs belonging to the same cluster are expected to have common features. Therefore, for example, the user creates a software component by extracting common feature code from the two or more sample programs and rewriting it into a reusable format.

For example, in a hierarchical level of t=0.8, multiple sample programs are classified into clusters 161, 162, and 163. The user creates one software component from the cluster 161. The user also creates one software component from the cluster 162. Further, the user creates one software component from the cluster 163. Note that the software components are reusable programs and may also be referred to as code instances, code patterns, program components, code snippets, or programming idioms.

However, due to the nature of machine learning scripts described above, a large number of sample programs which are candidates for software components are extracted from the machine learning scripts. Hierarchical clustering performed on a large number of sample programs produces a dendrogram with deep hierarchical levels. For this reason, it may be difficult for the user to select a hierarchical level suitable for software componentization from the dendrogram. In view of this problem, the information processor 100 calculates, for each of the multiple hierarchical levels, a hierarchical level evaluation value indicating whether the hierarchical level is suitable for software componentization, and selects an appropriate hierarchical level based on the hierarchical level evaluation values.

A hierarchical level evaluation value Pₜ of the hierarchical level t is given by Equation (1) below. The hierarchical level evaluation value Pₜ is the sum of cluster evaluation values P_{t,i} calculated for clusters C_{t,i} (i=1, 2, 3, and so on) residing in the hierarchical level t. Each cluster evaluation value P_{t,i} is the product of the first to fourth terms below.

$${P}_{t} = {\sum }_{i} {P}_{t , i} = {\sum }_{i} ( \vert {C}_{t , i} \vert * \frac{1}{{D}_{t , i}} ) * ( \frac{Σ {u}_{t , i}}{\vert {C}_{t , i}} * \frac{\vert {C}_{t , i} \vert}{{Σ ( {u}_{t , i} - {\overline{u}}_{t , i} )}^{2} + β} ) \qquad ( 1 )$$

The first term is the cluster size which indicates the number of sample programs included in the cluster. In Equation (1), |C_{t,i}| represents the cluster size of the cluster C_{t,i}. The cluster size relates to reusability of a software component to be created. Frequent occurrence of similar code indicates high reusability of the software component. Therefore, the larger the cluster size, the larger the cluster evaluation value P_{t,i}.

The second term is the cohesion degree of two or more sample programs included in the cluster. In Equation (1), 1/D_{t,i} represents the cohesion degree of the cluster C_{t,i}. The shorter the distance between sample programs in the cluster, the higher the degree of cohesion of the cluster. In addition, the greater the distance from sample programs belonging to other clusters, the higher the degree of cohesion. Features used for the calculation of the cohesion degree and those used for the hierarchical clustering may be the same or different. The cohesion degree relates to reusability of a software component to be created. A cluster with a high cohesion degree represents features of unique code different from those of other clusters. Therefore, the cluster evaluation value P_{t,i} increases as the cohesion degree increases.

For the cohesion degree, for example, the Calinski-Harabasz index or the Davies-Bouldin index is used. The Calinski-Harabasz index is inversely proportional to the variance of intra-cluster features and proportional to the variance of inter-cluster features. The variance of inter-cluster features is the variance of the distance between the center of the features of all the sample programs and the center of the features of each of the multiple clusters. The center of the features is, for example, the average value of the features.

The Davies-Bouldin index is obtained by dividing the sum of the variance of intra-cluster features of a first cluster and the variance of intra-cluster features of a second cluster, which most closely resembles the first cluster, by the inter-cluster distance. The second cluster is a cluster with the shortest inter-cluster distance from the first cluster. The inter-cluster distance is the distance between the center of the features of the first cluster and the center of the features of the second cluster.

Note that the cohesion degree may be calculated for each cluster, or may be calculated commonly for all the multiple clusters in the same hierarchical level. The Calinski-Harabasz index common to all the clusters is calculated using the average value of the intra-cluster variances of the multiple clusters. The Davies-Bouldin index common to all the clusters is the average value of the Davies-Bouldin indices of the individual clusters.

The Calinski-Harabasz index is described in the following non-patent literature: T. Calinski and J. Harabasz, “A Dendrite Method for Cluster Analysis”, Communications in Statistics, Volume 3, Issue 1, pages 1-27, January 1974. The Davies-Bouldin index is described in the following non-patent literature: David Davies and Donald Bouldin, “A Cluster Separation Measure”, IEEE Transactions on Pattern Analysis and Machine Intelligence, Volume 1, Issue 2, pages 224-227, April 1979.

The third term is the mean of the model accuracies of the sample programs included in the cluster. In Equation (1), u_{t,i} represents the model accuracies of the sample programs included in the cluster C_{t,i}. The mean of the model accuracies relates to the utility of the software component to be created. High model accuracy of a machine learning model trained using the software component indicates high utility of the software component. Therefore, the higher the mean of the model accuracies, the larger the cluster evaluation value P_{t,i}.

The fourth term is the reciprocal of the variance of the model accuracies of the sample programs included in the cluster. In Equation (1), β is a very small constant used to avoid zero variance and, for example, β=0.01. The reciprocal of the variance of the model accuracies relates to the utility of the software component to be created. Inconsistent model accuracy of a machine learning model trained with the software component indicates that the software component is not sufficiently fragmented. Therefore, the cluster evaluation value P_{t,i} increases as the variance of the model accuracies decreases.

For example, for the aforementioned cluster 161, the following are obtained: the cluster size is 100; the cohesion degree is 13; the mean of the model accuracies is 0.7; and the variance of the model accuracies is 1.25. In this case, the cluster evaluation value of the cluster 161 is 728. For the cluster 162, the followings are obtained: the cluster size is 150; the cohesion degree is 8; the mean of the model accuracies is 0.55; and the variance of the model accuracies is 1.0. In this case, the cluster evaluation value of the cluster 162 is 660. For the cluster 163, the followings are obtained: the cluster size is 1; the cohesion degree is 1; the mean of the model accuracies is 0.92; and the variance of the model accuracies is 0.01. In this case, the cluster evaluation value of the cluster 163 is 92. As a result, the hierarchical level evaluation value of the hierarchical level with t=0.8 is 1480.

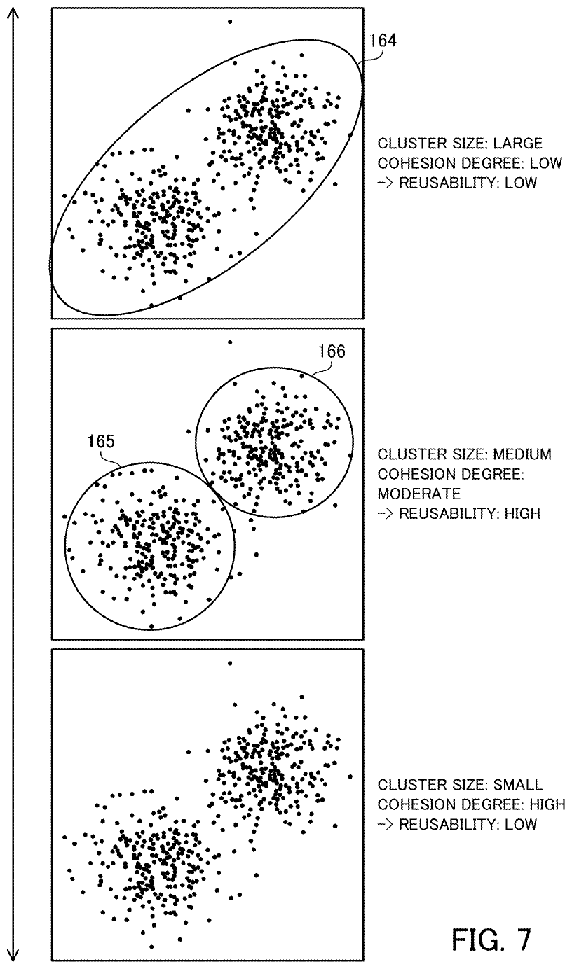

FIG. 7 illustrates an example of trade-off between cluster size and cohesion degree.

Here explanations are provided for the trade-off between cluster size and cohesion degree with respect to reusability of a software component to be created. A cluster 164 contains all sample programs. The cluster size of the cluster 164 is large. On the other hand, the cluster 164 has a wide distribution of features and, therefore, a low cohesion degree. As a result, the cluster 164 has a low degree of reusability, which is calculated as the product of the first term representing the cluster size and the second term representing the cohesion degree.

Clusters 165 and 166 are clusters residing in the same hierarchical level. The clusters 165 and 166 have medium cluster sizes. In addition, the clusters 165 and 166 have moderate cohesion degrees. Therefore, the clusters 165 and 166 have high degrees of reusability. In the hierarchical level of t=0, each sample program forms one source cluster. The source cluster is small in cluster size. On the other hand, the source cluster has the minimum intra-cluster variance and, therefore, high cohesion degree. As a result, the source clusters have low degrees of reusability. Thus, appropriate division of sample program clusters allows the product of the cluster size and the cohesion degree to be large.

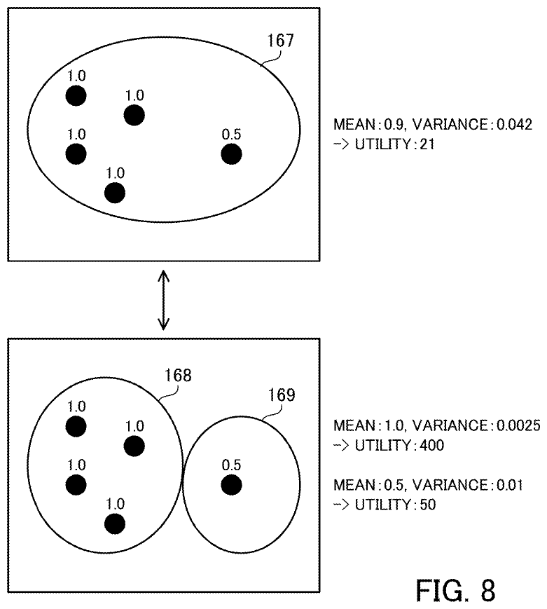

FIG. 8 illustrates an example of trade-off between the mean and variance of model accuracies.

Here explanations are provided for the trade-off between the mean and variance of model accuracies with respect to utility of a software component to be created. A cluster 167 contains five sample programs. Four of the sample programs have a model accuracy of 1.0 while one sample program has a model accuracy of 0.5. The mean and variance of the model accuracies of the cluster 167 are 0.9 and 0.042, respectively. As a result, the cluster 167 has a utility of 21, which is calculated as the product of the third term representing the mean of the model accuracies and the fourth term representing the reciprocal of the variance of the model accuracies.

Clusters 168 and 169 are clusters residing in the same hierarchical level. The cluster 168 contains four sample programs each having a model accuracy of 1.0. The cluster 169 contains one sample program with a model accuracy of 0.5. The mean and variance of the model accuracies of the cluster 168 are 1.0 and 0.0025, respectively. Therefore, the utility of the cluster 168 is 400. On the other hand, the mean and variance of the model accuracies of the cluster 169 are 0.5 and 0.01, respectively. Therefore, the utility of the cluster 169 is 50. Thus, when sample programs with similar model accuracies gather, the total product of the mean and the reciprocal of the variance of the model accuracies increases.

Next described are functions and processing procedures of the information processor 100.

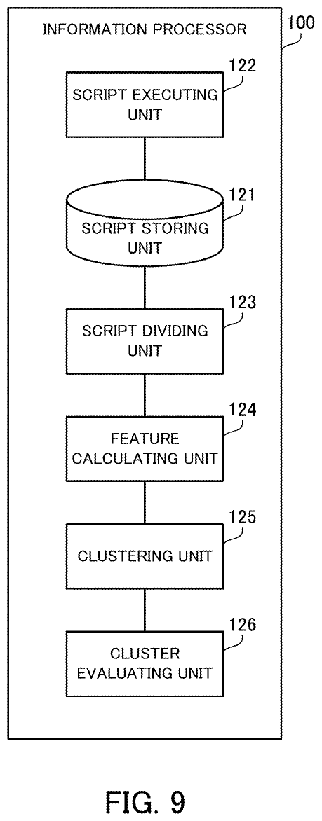

FIG. 9 is a block diagram illustrating an example of functions of an information processor.

The information processor 100 includes a script storing unit 121, a script executing unit 122, a script dividing unit 123, a feature calculating unit 124, a clustering unit 125, and a cluster evaluating unit 126. The script storing unit 121 is implemented using, for example, the RAM 102 or the HDD 103. The script executing unit 122, the script dividing unit 123, the feature calculating unit 124, the clustering unit 125, and the cluster evaluating unit 126 are implemented using, for example, the CPU 101 or the GPU 104 and programs.

The script storing unit 121 stores therein collected existing machine learning scripts. The script storing unit 121 also stores training data and test data for executing the machine learning scripts. Further, the script storing unit 121 stores model accuracies corresponding to the machine learning scripts. The model accuracies are measured by the script executing unit 122.

The script executing unit 122 executes the machine learning scripts stored in the script storing unit 121 using the training data and the test data. The GPU 104 may be used to execute the machine learning scripts. The script executing unit 122 stores, in the script storing unit 121, the model accuracies measured for the machine learning scripts.

Note that, if a machine learning script does not include code for measuring the model accuracy, the script executing unit 122 may measure the model accuracy of a trained machine learning model outside of the machine learning script. In addition, if the features of each sample program are calculated from memory states, the script executing unit 122 stores, in the script storing unit 121, a memory image for each step during execution of the machine learning script.

The script dividing unit 123 divides the machine learning scripts stored in the script storing unit 121 into multiple sample programs. For example, the script dividing unit 123 extracts n consecutive lines of code (n=1, 2, 3, and so on) as sample programs. A set of sample programs generated here may include sample programs extracted from different machine learning scripts. The script dividing unit 123 gives, to each sample program, the model accuracy of a corresponding original machine learning script.

The feature calculating unit 124 calculates features of each sample program extracted by the script dividing unit 123. For example, the feature calculating unit 124 extracts tokens from each sample program and calculates, as the features, a token vector which indicates the presence or absence of the tokens.

The clustering unit 125 executes hierarchical clustering on the multiple sample programs extracted by the script dividing unit 123 based on the features calculated by the feature calculating unit 124. Herewith, a dendrogram is generated that represents the classification results of sample programs in each of multiple hierarchical levels having different numbers of clusters.

According to the aforementioned Equation (1), the cluster evaluating unit 126 calculates the cluster evaluation value of each cluster from the results of the hierarchical clustering by the clustering unit 125 and the model accuracy given to each sample program. The cluster evaluating unit 126 calculates, for each of the multiple hierarchical levels, a hierarchical level evaluation value obtained by adding together the cluster evaluation values of clusters residing in the hierarchical level. The cluster evaluating unit 126 selects a hierarchical level with the largest hierarchical level evaluation value.

The cluster evaluating unit 126 may store the clustering results of the selected hierarchical level in a non-volatile storage device; display them on the display device 111; and/or transmit them to different information processors. The cluster evaluating unit 126 may also prompt the user to create software components from clusters included in the selected hierarchical level. In addition, the cluster evaluating unit 126 may rank sample programs according to certain criteria for each cluster in the selected hierarchical level, and present upper-ranked sample programs to the user as strong candidates for a software component.

Alternatively, the cluster evaluating unit 126 may select, from each cluster, sample programs whose features are closest to the center of the cluster as strong candidates for a software component. The cluster evaluating unit 126 may present to the user, amongst two or more clusters residing in the selected hierarchical level, only clusters with cluster evaluation values exceeding a threshold or clusters with top cluster evaluation values. The information processor 100 may receive, from the user, software components edited based on the sample programs and store the received software components. Further, the information processor 100 may transmit the received software components to different information processors.

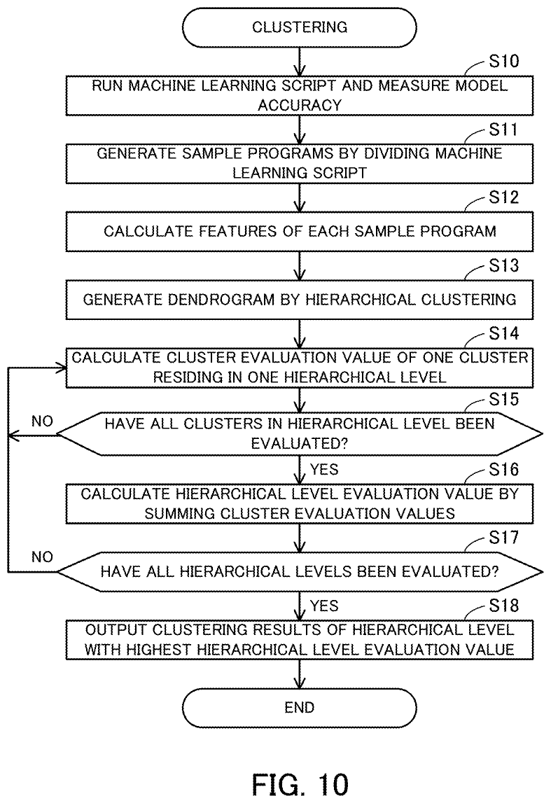

FIG. 10 is a flowchart illustrating an example of a clustering procedure.

(Step S10) The script executing unit 122 runs a machine learning script to measure the model accuracy of a machine learning model trained using the machine learning script.

(Step S11) The script dividing unit 123 divides the machine learning script to generate multiple sample programs, and gives the model accuracy to each of the sample programs.

(Step S12) The feature calculating unit 124 extracts tokens from the multiple sample programs and calculates, for each sample program, features indicating the presence or absence of the tokens.

(Step S13) Using the features obtained in step S12, the clustering unit 125 performs hierarchical clustering for classifying the multiple sample programs into clusters while decreasing the number of clusters in stages. Herewith, the clustering unit 125 generates a dendrogram representing the results of the hierarchical clustering.

(Step S14) The cluster evaluating unit 126 selects one hierarchical level from the dendrogram. The cluster evaluating unit 126 selects one cluster residing in the selected hierarchical level. The cluster evaluating unit 126 calculates the cluster evaluation value of the selected cluster according to the aforementioned Equation (1). The cluster evaluation value is the product of the first term representing the cluster size, the second term representing the cohesion degree, the third term representing the mean of the model accuracies, and the fourth term representing the reciprocal of the variance of the model accuracies.

(Step S15) The cluster evaluating unit 126 determines whether all clusters in the selected hierarchical level have been evaluated. If all the clusters have been evaluated, the process moves to step S16. If there is one or more clusters that have yet to be evaluated, the process returns to step S14 and the next cluster is then selected.

(Step S16) The cluster evaluating unit 126 sums the cluster evaluation values of all the clusters residing in the selected hierarchical level to calculate the hierarchical level evaluation value of the selected hierarchical level.

(Step S17) The cluster evaluating unit 126 determines whether all hierarchical levels included in the dendrogram have been evaluated. If all the hierarchical levels have been evaluated, the process moves to step S18. If there is one or more hierarchical levels that have yet to be evaluated, the process returns to step S14 and the next hierarchical level is then selected.

(Step S18) The cluster evaluating unit 126 selects, from the dendrogram, a hierarchical level with the highest hierarchical level evaluation value. The cluster evaluating unit 126 outputs the clustering results of the selected hierarchical level.

As has been described above, the information processor 100 of the second embodiment extracts a set of sample programs from existing machine learning scripts, and classifies the set of sample programs into two or more clusters by hierarchical clustering. Herewith, clusters suitable to be made into individual single software component are presented to the user, thus streamlining the work of creating software components related to machine learning scripts.

The information processor 100 also calculates a cluster evaluation value for each cluster, and calculates, for each of multiple hierarchical levels having different numbers of clusters, a hierarchical level evaluation value from the cluster evaluation values. Then, the information processor 100 selects, amongst the clustering results of the multiple hierarchical levels, the clustering results of a hierarchical level with the highest hierarchical level evaluation value. This eliminates the need for manually determining an appropriate hierarchical level from the multiple hierarchical levels, and streamlines the work of creating software components. In particular, even when a dendrogram with deep hierarchical levels is generated from a large number of sample programs, a hierarchical level suitable for creating software components is automatically determined.

In addition, the information processor 100 calculates, as a cluster evaluation value for each cluster, the product of the first term representing the cluster size, the second term representing the cohesion degree of intra-cluster features, the third term representing the mean of model accuracies within the cluster, and the fourth term representing the reciprocal of the variance of the model accuracies within the cluster. Herewith, clusters are evaluated from the view point of reusability and utility of software components, which allows for creating high-quality software components from clusters with high cluster evaluation values.

According to one aspect, it is possible to streamline creation of software components from sample programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring cluster data and performance data, the cluster data representing classification results obtained by classifying a plurality of sample programs into two or more clusters and arranging the two or more clusters in a plurality of levels in such a manner that each of the plurality of levels contains a different number of the two or more clusters, the performance data representing an execution performance of each of the plurality of sample programs;
calculating, for each of the two or more clusters in each of the plurality of levels, a first evaluation value based on an index value for reusability of two or more sample programs belonging to the cluster and the execution performances of the two or more sample programs;
calculating, for the level, a second evaluation value based on two or more first evaluation values corresponding to the two or more clusters; and
selecting, based on the second evaluation values corresponding to the plurality of levels, the classification results of one level amongst the plurality of levels.

2. The non-transitory computer-readable recording medium according to claim 1, wherein the plurality of levels is a plurality of hierarchical levels generated by hierarchical clustering that iteratively integrates different clusters.

3. The non-transitory computer-readable recording medium according to claim 1, wherein the execution performance of each of the plurality of sample programs is prediction accuracy of a machine learning model trained using the sample program.

4. The non-transitory computer-readable recording medium according to claim 1, wherein the first evaluation value corresponding to each of the two or more clusters is calculated based on a first index value representing a number of sample programs of the cluster, a second index value representing a cohesion degree corresponding to variance of features related to description of the two or more sample programs belonging to the cluster, a third index value representing mean of the execution performances associated with the cluster, and a fourth index value representing variance of the execution performances associated with the cluster.

5. An information processing method executed by a computer, the information processing method comprising:
acquiring cluster data and performance data, the cluster data representing classification results obtained by classifying a plurality of sample programs into two or more clusters and arranging the two or more clusters in a plurality of levels in such a manner that each of the plurality of levels contains a different number of the two or more clusters, the performance data representing an execution performance of each of the plurality of sample programs;
calculating for each of the two or more clusters in each of the plurality of levels, a first evaluation value based on an index value for reusability of two or more sample programs belonging to the cluster and the execution performances of the two or more sample programs;
calculating, for the level, a second evaluation value based on two or more first evaluation values corresponding to the two or more clusters; and
selecting based on the second evaluation values corresponding to the plurality of levels, the classification results of one level amongst the plurality of levels.

6. An information processing apparatus comprising:
a memory configured to store cluster data and performance data, the cluster data representing classification results obtained by classifying a plurality of sample programs into two or more clusters and arranging the two or more clusters in a plurality of levels in such a manner that each of the plurality of levels contains a different number of the two or more clusters, the performance data representing an execution performance of each of the plurality of sample programs; and
a processor coupled to the memory and the processor configured to:
calculate, for each of the two or more clusters in each of the plurality of levels, a first evaluation value based on an index value for reusability of two or more sample programs belonging to the cluster and the execution performances of the two or more sample programs;
calculate, for the level, a second evaluation value based on two or more first evaluation values corresponding to the two or more clusters; and
select, based on the second evaluation values corresponding to the plurality of levels, the classification results of one level amongst the plurality of levels.
